(19) United States
(12) Patent Application Publication
(10) Pub. No.: US 2017/0273274 A1
(43) Pub. Date: Sep. 28, 2017

(54) FEEDER

(71) Applicant: TDJ Enterprises, LLC, Alexandria, KY (US)

(72) Inventor: TROY MICHAEL SHELDON, Alexandria, KY (US)

(21) Appl. No.: 15/460,740

(22) Filed: Mar. 16, 2017

Related U.S. Application Data
(60) Provisional application No. 62/311,630, filed on Mar. 22, 2016.

(51) Int. Cl. A01K 5/01

(52) U.S. Cl. CPC A01K 5/01

(57) ABSTRACT

A feeder includes a feed container and an underlying integral shroud depending from the container, with a socket for receiving a supporting post. An upwardly open funnel is optionally disposed centrally in the feed container for receiving and presenting a variety of feed supplements apart from feed in the feed container.

### RELATED APPLICATION

The present application claims priority to U.S. Ser. No. 62/311,630 filed Mar. 22, 2016, the disclosure of which is hereby incorporated herein by reference in its entirety.

### FIELD OF THE INVENTION

This invention relates to feeders for livestock or wild life including both domesticated and non-domesticated animals.

### BACKGROUND OF THE INVENTION

Feeders for livestock and wildlife are known, however, problems persist with known devices. Automated devices require moving parts and provision of a power source. Non-automated, or non-moving passive devices exhibit problems or usage issues of their own. Mounting or positioning pose difficulties when considering feeder access by non-desirable animals such as mice, opossum, raccoons, squirrels, etc. Also, the disposition of a feeder on uneven or slanted ground typically found in feeder environments causes tilting or uneven feeder orientation. Feed degradation by moisture retained in the feeder can be problematic. Delivery of two or more varied types of feed or supplements is not typically accommodated. Durability, resistance to extreme temperature swings, UV resistance and other functional attributes in a passive feeder are desired.

Accordingly, it is one objective of the invention to provide a passive feeder for livestock, wild animals and both domesticated and non-domesticated animals with limited access by non-desired animals and rodents.

Another objective of the invention has been to provide a feeder with unique mounting structure for easily disposing the feeder in desired positions for the targeted animals to be fed.

Another objective of the invention has been to provide a feeder for presenting multiple types of feed and feed supplements.

A further objective of the invention has been to provide an outdoor animal feeder with provision for reducing feed spoilage by eliminating moisture retention.

### SUMMARY OF THE INVENTION

To these ends a preferred embodiment of the invention includes an elevated animal feeder mounted on the top of a heavy duty steel post, preferably a “T-post” having a t-shaped cross-section. Alternatively, the feeder can be situated directly on the ground. When mounted to a T-post, a clamping adapter plate clamps about the T-post and is held by the threaded fasteners extending into the feeder. The feeder is preferably but not necessarily, in an annular configuration, open upwardly for animal access. An upwardly opening funnel shaped container is situated centrally within the feeder for holding a second feed material such as minerals, or wet feeds such as molasses. Drain holes in the feeder floor permit moisture drainage.

An integral base shroud having a depending annular skirt depends downwardly from the annular periphery of the upper feed container portion of the feeder, serving to prevent access by undesirable animals such as those noted above.

The feeder and shroud preferably form an integral structure made of a UV-resistant, durable synthetic materials such as linear, low density polyethylene, and can be formed by any suitable process such as rotational molding.

The feeder is mountable on any traditional steel T-post driven into the ground or otherwise mounted. Such T-posts have general T-shaped cross-section, acceptable by a cooperating recess in a socket boss of the base shroud. This shroud is perforated allowing passage of moisture from the holes in the feeder floor holes, and has four radial stiffening wings supporting the feeder.

Preferably, the integral feeder and base shroud are formed integrally in one process, and the integral feeders, including shrouds, are thus stackable for storage or shipment with the shroud portion of an upper feeder fitting within the feed container portion of a lower feeder.

These and other features and advantages of the invention are described below in a written detailed description of the invention and from the drawings in which:

### BRIEF DESCRIPTION OF THE DRAWINGS

FIG. 1 is an isometric view of the integral feeder invention in place on a post;

FIG. 2 is an isometric view of the integral feeder of FIG. 1 in an enlarged scale omitting the post;

FIG. 3 is an isometric view of the bottom of the integral feeder of FIG. 2;

FIG. 4 is also an isometric view of the bottom of the integral feeder as in FIG. 3 but from a different angle;

FIG. 5 is an isometric view of the bottom of the integral feeder of FIG. 4 showing also a mounting post and post clamping plate;

FIG. 6 is a partial cross-sectional view of the post-mounted integral feeder of FIG. 1;

FIG. 7 is a top isometric view of the integral feeder of FIGS. 1 and 2;

FIG. 8 is an isometric view of the central funnel of the feeder as shown in FIGS. 1 and 2;

FIG. 9 is an isometric view of the feeders of FIGS. 3 and 4 in stacked orientation.

FIG. 10 is a cross-sectional view of a typical T-post of FIGS. 1, 5 and 6;

FIG. 11 is an isometric view of a one-half feeder alternative embodiment; and

FIG. 11A is a top plan view lined drawing of the one-half feeder of FIG. 11;

FIG. 11B is a bottom line-view of the feeder of FIGS. 11 and 11A.

FIG. 12 is an isometric view of a one-quarter feeder alternative embodiment.

FIG. 12A is a top plan view line drawing of the feeder of FIG. 12; and

FIG. 12B is a bottom line drawing view of the feeder of FIGS. 12 and 12A.

### DETAILED DESCRIPTION OF THE INVENTION

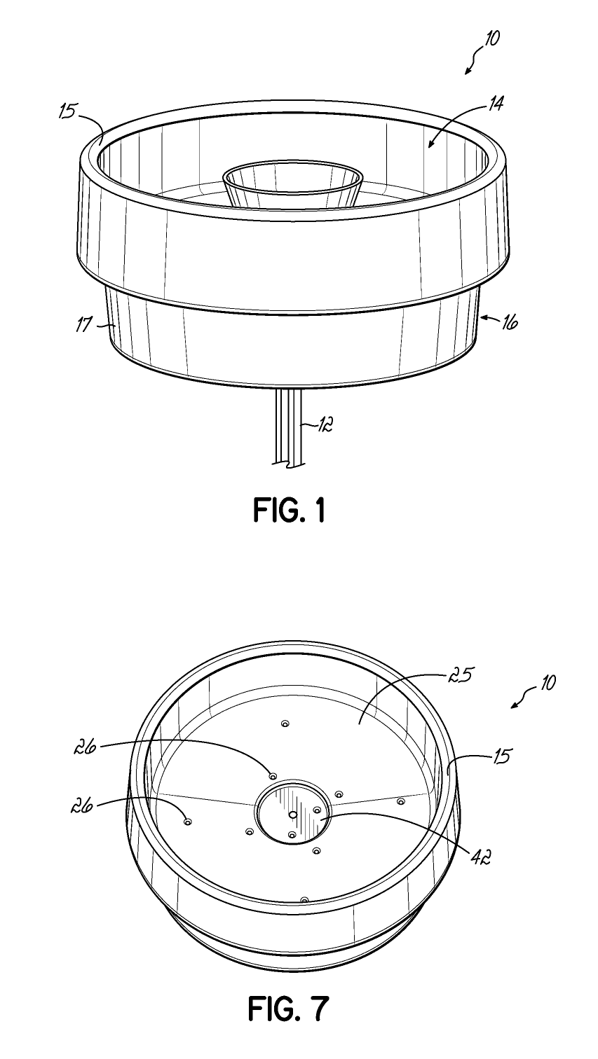

Turning now to the drawings, a feeder 10, according to the invention is shown mounted on a post 12 in FIG. 1. Feeder 10 is preferably integrally formed of a suitable synthetic material by a suitable rotational molding process, and including component portions of a feed container 14 with an integrally formed downwardly depending shroud portion 16.

Feed container 14 is preferably in the form of a concave bowl with an upstanding annular wall 15, while shroud portion 16 includes an annular, downwardly depending wall or skirt 17 slightly radially inset from wall 15.

Shroud portion 16 further includes four integral ribs 18a-18d and a socket 20 for receiving post 12.

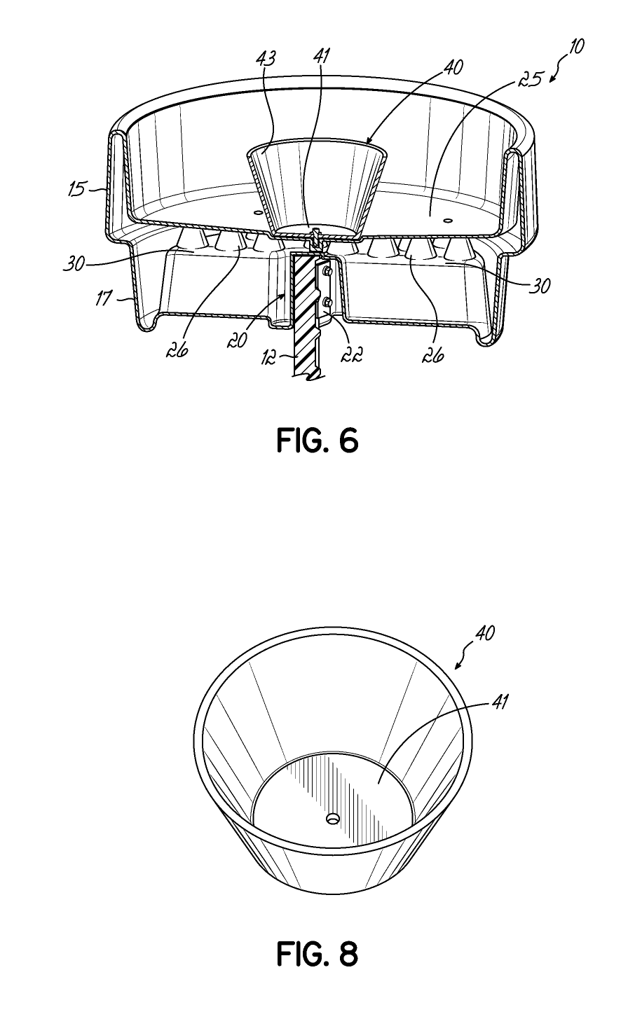

When post 12 is inserted into socket 20, a clamping adapter plate 22 is disposed about post 20 with threaded fasteners extending from plate edges therethrough to clamp post 12 to socket 20 and hold feeder 10 in place all as illustrated in FIGS. 5 and 6. In this regard, socket 20 is preferably smaller than the post, which is then pressed into the socket by the application of the adapter plate 22.

Post 12 is preferably a heavy duty steel, T-shaped post, typically used and available as a heavy duty T-post or fence post and preferably stout enough to withstand moments of inertia expected from the supported feeder in use. Post 12 is illustrated in typical cross-section as in FIG. 10. Socket 20 comprises a complimentary recess for receiving the T-post.

Otherwise, a socket is formed for accepting other posts or other support configurations. Such other support configurations may include a bracket or other structure not requiring mounting the feeder 10 in the ground.

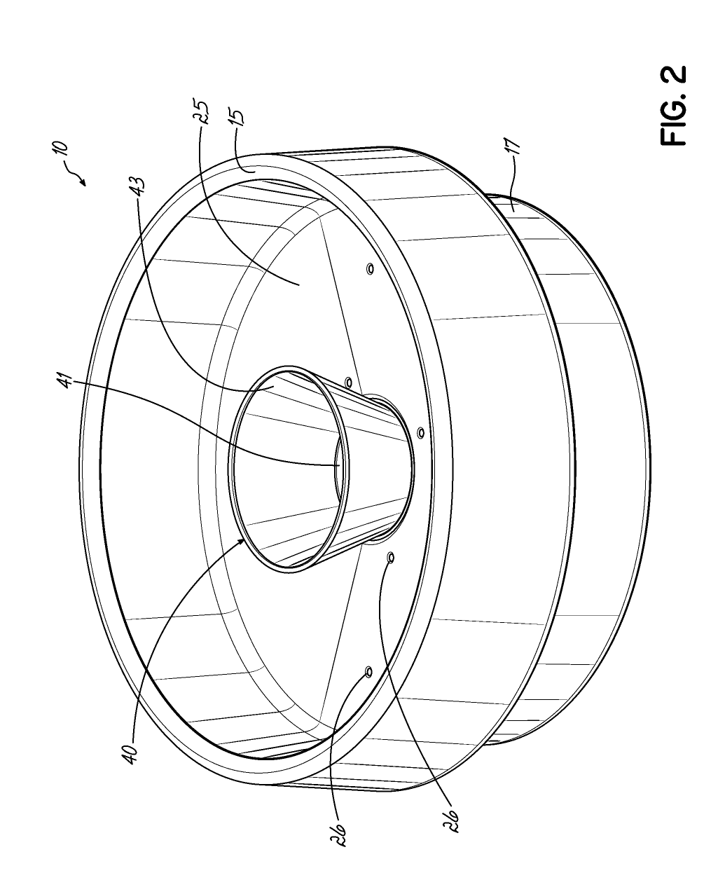

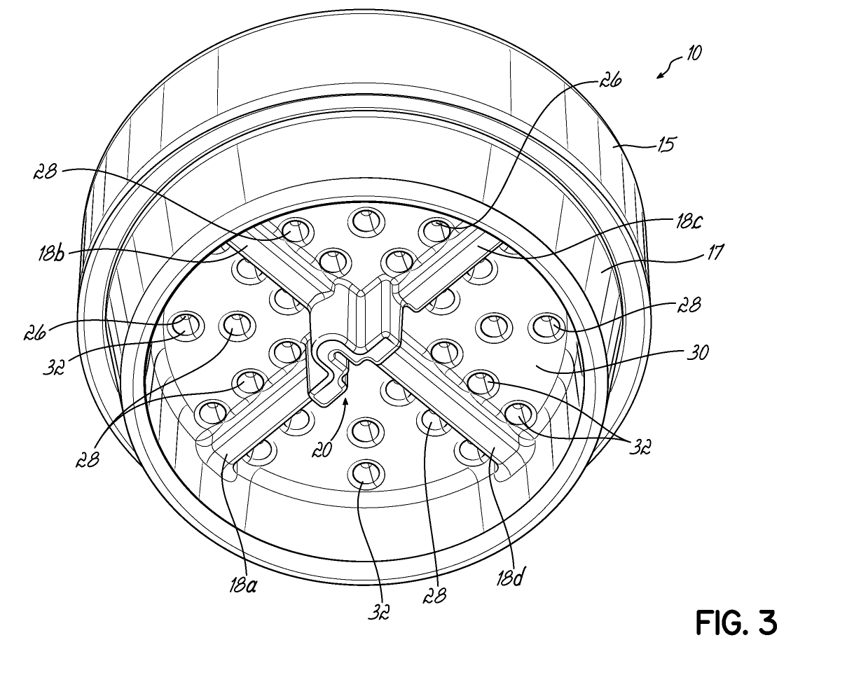

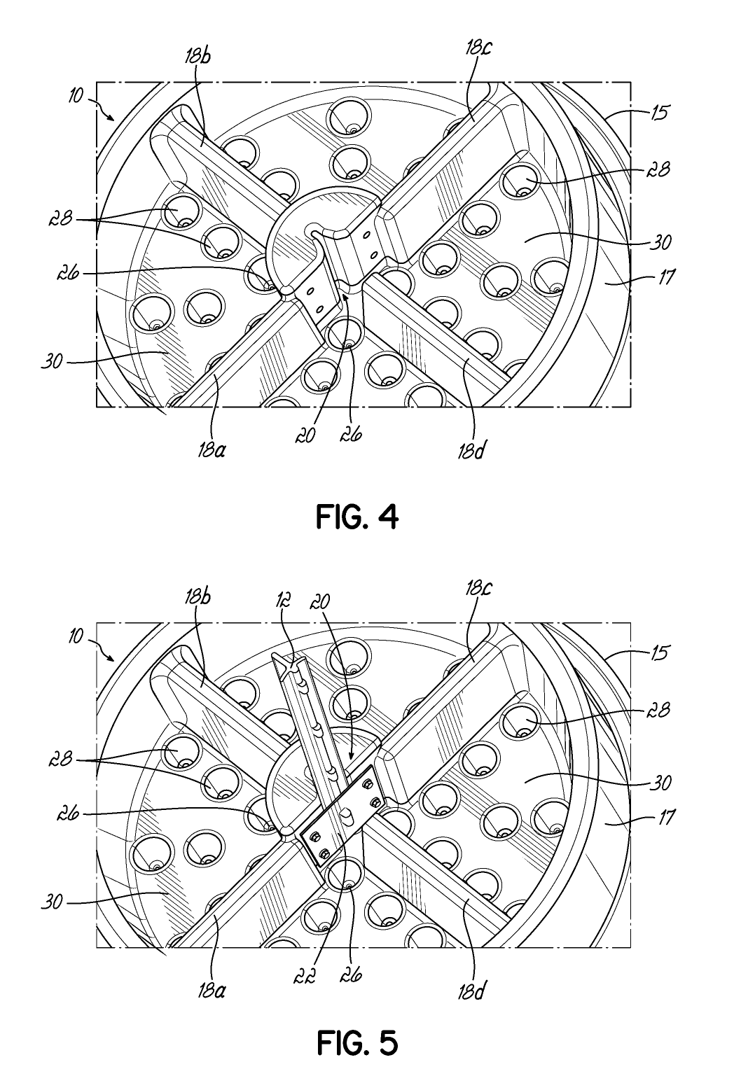

As perhaps best seen in FIGS. 2, 3, 4, 6 and 7, feed container portion 14 includes a feed supporting floor 25 with a plurality of holes 26. Hollow, integral support columns 28 are indexed with holes 26 and extend upwardly from shroud panel 30 to floor panel 25 in support thereof. The lower portion of columns 28 are open and through holes 32 in panel 30 to permit drainage of moisture in feed container 14 out of feeder 10.

Ribs 18a-18d add strength to shroud portion (16, 17) and feeder 10 and may integrally extend from socket 20 for rigidity.

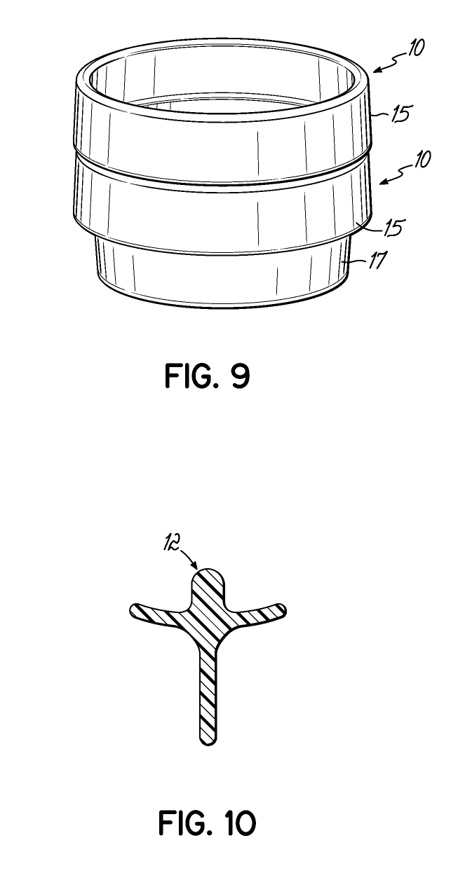

As shown in FIG. 9, one or more feeders (without the optional cone) are stackable with shroud portions 16 of an upper feeder nestable in the feed containers portion 14 of a lower feeder.

As noted earlier, feeder 10 is preferably an integral structure formed by the suitable process such as rotational molding. Feeder 10 is preferably formed from a synthetic material such as linear, low density polyethylene of FDA approved material and having a resistance to UV degradation. The feeder material withstands temperature variances in normal use.

As shown in FIGS. 1, 2, 6 and 8 the invention contemplates a separate, funnel-shaped or cone-shaped feed container 40 with a narrow lower end removeably fitting in a recess 42 of floor panel 25 of feed container 14. The lower end 41 of funnel or cone 40 is preferably closed, while the larger end 43 is open. Funnel 40 can be filled with dry or wet feed supplements such as minerals or molasses, etc. where desired, and is made similarly to and with materials like that of feeder 10. Lower end 41 is secured with a fastener into feeder 10, as illustrated, through the cone bottom into the integral feeder for securing the cone. Preferably, the cone base does not cover any of the drain holes 26.

### Alternative Embodiments

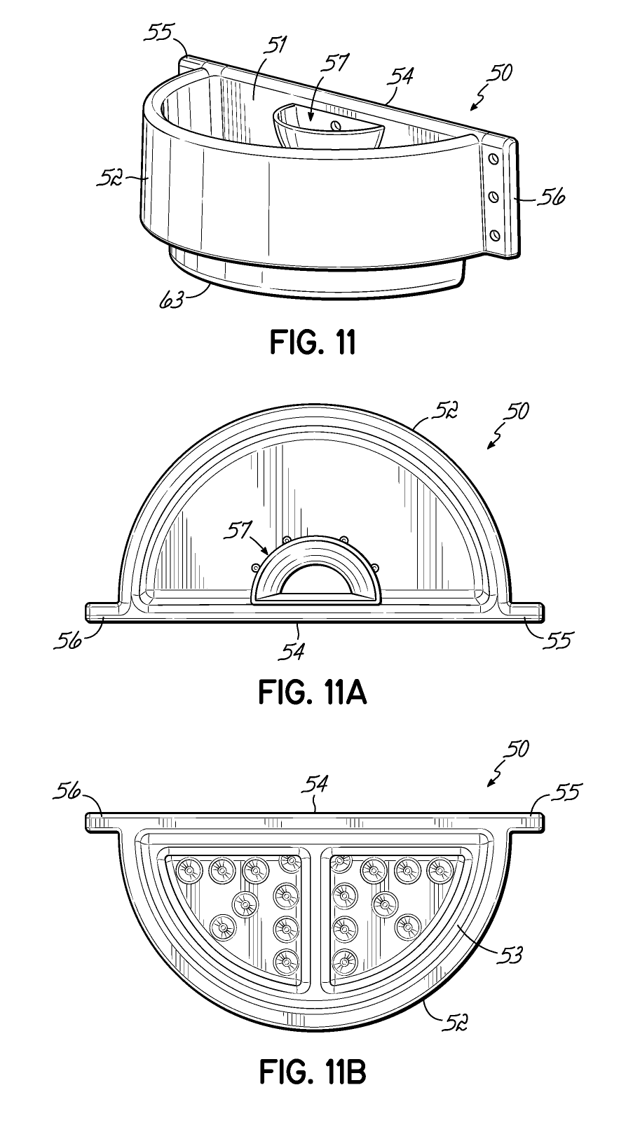

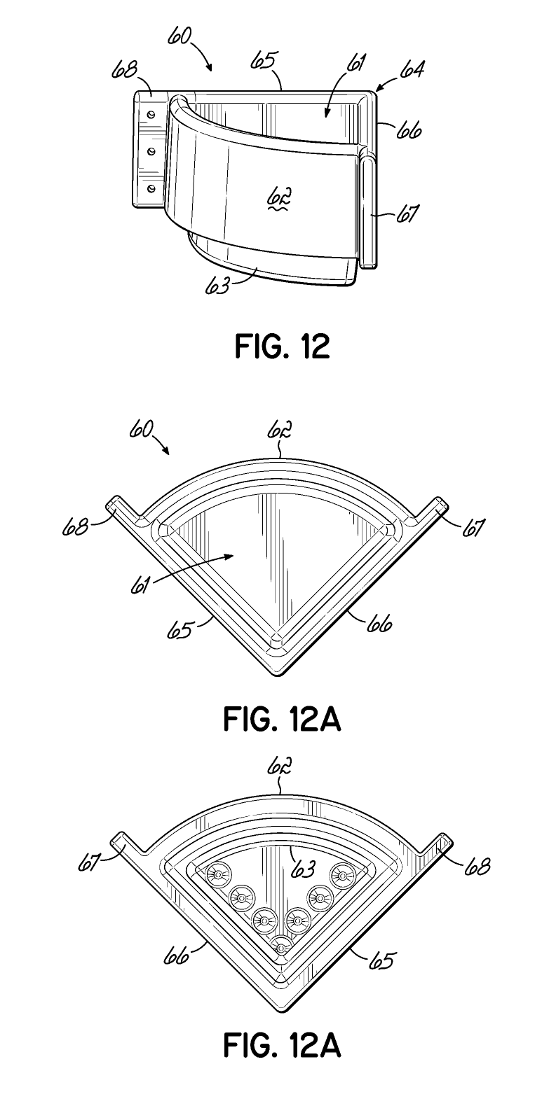

One alternative embodiment includes a feeder 50 as in FIG. 11, particularly suitable for mounting on a flat surface such as a flat fence member or on the flat side of a structure (not shown). In this embodiment a T-post is not used.

The feeder 50 includes a feed container 51 defined by a semi-circular feeder wall 52, a semi-annular floor and a depending semi-circular shroud 53 depending under container 51.

An integral flat wall 54 extends across container 51 forming a back wall with end flanges 55, 56, preferably drilled for fasteners therethrough into any suitable flat fence or structural surface for mounting feeder 50 thereon. A one-half funnel-shaped cone 57 can be integrally formed or is provided as a separate part for installation as in FIG. 11 for holding a feed of another property than feed placed in container 51.

Drain holes are provided in a floor of container 51 for draining out moisture in container 51. Otherwise the walls, skirt and floor of feeder 50 are similar to those of the embodiment described above.

Thus this embodiment embodies slightly different structure to accommodate a different mounting of the feeder on a flat surface, as opposed to mounting on a T-post.

A second alternative embodiment feeder 60 is shown in FIG. 11.

This embodiment is particularly useful for mounting a feeder in a corner of a fence or as defined by intersecting walls of a structure.

Feeder 60 includes a feed container 61 with a curved wall 62 extending 90° in curvature and a depending curved shroud 63 of similar curvilinear extension. An angled integral back wall 64 has two wall components 65, 66 intersecting at an angle and each provided with an extending end flange 67, 68, drilled for the extension of fasteners therethrough into respective intersecting fence slats or corner walls of a structure. A corner funnel of 90° extension (not shown) may be included on back wall 64 within container 60 to hold a feed material as well similarly to the other shaped funnels of feeders 10 and 50. Drain holes may be provided in a container floor for draining moisture from container 61.

This embodiment enables feeder 60 to be mounted in a corner defined by corner structure of a fence or building, for example and without use of a T-post.

Advantages of the feeders described herein include:
durability
odor neutral
UV resistance
structural rigidity in use
FDA material with no BPA
moisture drains
easily mounted on a typical steel fence post (alternately on flat or corner surfaces)
optional accessory cone for multiple feed materials or supplements, dry or wet
raccoon or opossum protection
temperature durability in expected temperature ranges of use
stackable for shipping or storage.
   Uses of the invention are numerous, including but not limited to:
cattle feeding
alpaca and llama feeding
equine feeding
goat feeding
sheep feeding
deer hunters
wildlife observers and wildlife enthusiasts
other domestic or non-domestic animals
FFA, 4H and other student livestock enthusiasts.

What is claimed is:

1. A feeder comprising:
a feed container,
a feeder shroud;
a socket formed with said feeder;
said socket having an aperture for fitting over a post for supporting said feeder;
said feed container including a surrounding feeder wall; and
said feeder shroud having a depending skirt extending below said feed container.

2. A feeder as in claim 1 further including a plurality of ribs beneath said container.

3. A feeder as in claim 1 including a plurality of drain holes in said feed container and in said shroud.

4. A feeder as in claim 1 wherein the feeder shroud is nestable within a feed container of another feeder.

5. A feeder as in claim 1 wherein said feed container and said feeder shroud are integrally formed together and further including a plurality of support columns extending therebetween.

6. A feeder as in claim 1 further including a support operatively coupled to the feeder.

7. A feeder for mounting on a flat surface and said feeder comprising:
a feed container comprising a semicircular container wall having respective ends;
a feeder shroud;
said shroud comprising a semicircular skirt depending below said feed container;
said container comprising a back wall having respective ends extending outwardly away from said respective ends of said container wall;
said back wall comprising a flat wall for engaging a flat surface of a mounting structure.

8. A feeder for mounting in a corner of a mounting structure, said structure having surfaces perpendicularly to each other, said feeder comprising
a feed container comprising a partially circular container wall extending through a 90° curve to a respective back wall;
a feeder shroud depending beneath said feed container;
said wall having respective ends extending to respective ones of a respective back wall;
said back wall having respective flanges extending outwardly of respective ends of said wall, said flanges disposed perpendicularly with respect to each other.
